(19) United States
(12) Patent Application Publication
(10) Pub. No.: US 2017/0122255 A1
(43) Pub. Date: May 4, 2017

(54) CHEVRON SYSTEM FOR GAS TURBINE ENGINE

(71) Applicant: PRATT & WHITNEY CANADA CORP., Longueuil (CA)

(72) Inventors: Ninad Joshi, Brampton (CA); Sid-Ali Meslioui, Brossard (CA)

(21) Appl. No.: 14/925,500

(22) Filed: Oct. 28, 2015

(51) Int. Cl. F02K 1/46; F02K 1/34; F01D 25/24; F02K 1/54; F02K 1/08

(52) U.S. Cl. CPC F02K 1/46; F02K 1/54; F02K 1/08; F01D 25/24; B64D 33/06; F05D 2260/962; F05D 2220/32

(57) ABSTRACT

A surface-increasing feature system for a gas turbine engine comprising deployable surface-increasing features such as chevrons each defined by panels connected to a deployment mechanism providing a translational actuation to deploy said deployable surface-increasing feature from a stowed configuration concealed fore of a trailing edge of a case of the gas turbine engine, to a deployed configuration extending beyond the trailing edge. Joints provide one or more degree of freedom for the first panel and the second panel relative to the deployment mechanism. A guide operatively contacts the deployable surface-increasing feature to rotatably displace the first panel and the second panel away from one another in the at least one degree of freedom in response to movement induced by the translational actuation from the stowed configuration to the deployed configuration. A footprint of the deployable surface-increasing feature concurrently defined by the first panel and the second panel is greater in the deployed configuration than in the stowed configuration

### TECHNICAL FIELD

The application relates generally to gas turbine engines and, more particularly, to chevrons and like surface-increasing features.

### BACKGROUND OF THE ART

The exhaust jet of a gas turbine engine remains a significant noise source, particularly at high power conditions. Chevrons located at the trailing edge of nozzles have emerged as an effective means of noise reduction in mid-to-high bypass ratio turbo-fan engines. The chevrons are the saw-tooth patterns on the trailing edges of jet engine nozzles. The chevron nozzles induce additional mixing mechanisms within the shear layer thereby promoting a rapid plume decay and resulting in noise reduction. This may however be accompanied by an increased drag which results in a deterioration of the performance of the gas turbine engine.

### SUMMARY

In one aspect, there is provided a surface-increasing feature system for a gas turbine engine comprising: at least one deployable surface-increasing feature defined at least by a first panel and a second panel connected to a deployment mechanism providing a translational actuation to deploy said deployable surface-increasing feature from a stowed configuration in which the deployable surface-increasing feature is substantially concealed fore of a trailing edge of a case of the gas turbine engine, to a deployed configuration in which the deployable surface-increasing feature extends beyond the trailing edge; at least one joint providing at least one degree of freedom for the first panel and the second panel relative to the deployment mechanism; and a guide operatively contacting the deployable surface-increasing feature to rotatably displace the first panel and the second panel away from one another in the at least one degree of freedom in response to movement induced by the translational actuation from the stowed configuration to the deployed configuration; whereby a footprint of the deployable surface-increasing feature concurrently defined by the first panel and the second panel is greater in the deployed configuration than in the stowed configuration.

In a second aspect, there is provided a chevron system for a gas turbine engine comprising: at least one chevron defined by a pair of panels, each panel having at least two degrees of freedom, with one degree of freedom consisting of a rotational movement of said panel around a joint and another degree of freedom consisting of translational movement of said panel within a guide; a biasing member for biasing the panels in said rotational movement, wherein said rotational movement is restricted by the guide; and a deployment mechanism for moving each panel within the guide.

In a third aspect, there is provided a method for deploying a pair of panels forming a surface-increasing feature at a trailing edge of a case of a gas turbine engine of an aircraft, comprising: receiving a translational actuation to move the surface-increasing feature beyond the trailing edge; and guiding the two panels in rotatably moving relative to one another as induced by the translational actuation to increase a footprint of the deployable surface-increasing feature concurrently defined by the first panel and the second panel.

Further details of these and other aspects of the present invention will be apparent from the detailed description and figures included below.

### DESCRIPTION OF THE DRAWINGS

Reference is now made to the accompanying figures, in which:

FIG. 1A is a schematic cross-sectional view of a short-cowl turbofan gas turbine engine;

FIG. 1B is a schematic cross-sectional view of a long-cowl turbofan gas turbine engine;

FIGS. 2A and 2B are a schematic enlarged section view, and a schematic end view, respectively, of a case of a gas turbine engine enclosing a chevron deployment mechanism, with chevrons stowed;

FIGS. 3A and 3B are a schematic enlarged section view, and a schematic end view, respectively, of the case of the gas turbine engine enclosing the chevron deployment mechanism of FIGS. 2A and 2B, with chevrons deployed;

FIGS. 4A and 4B are schematic footprint views of a chevron system in accordance with the present disclosure, respectively in a deployed configuration and in a stowed configuration;

FIG. 5 is a schematic footprint view of a chevron system in accordance with the present disclosure, in a deployed configuration;

FIGS. 6A and 6B are schematic footprint views of a chevron system in accordance with the present disclosure and sharing a common pivot, respectively in a deployed configuration and in a stowed configuration; and

FIG. 7 is a schematic view showing reinforcement members of an end frame, configured to receive the chevron system of the present disclosure.

### DETAILED DESCRIPTION OF THE PREFERRED EMBODIMENTS

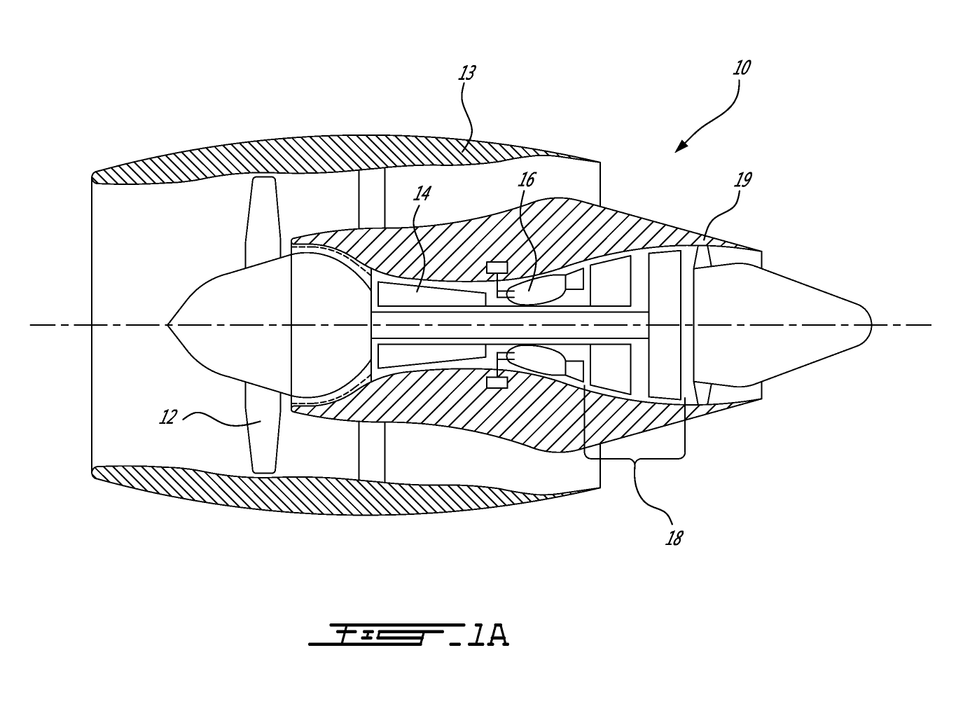

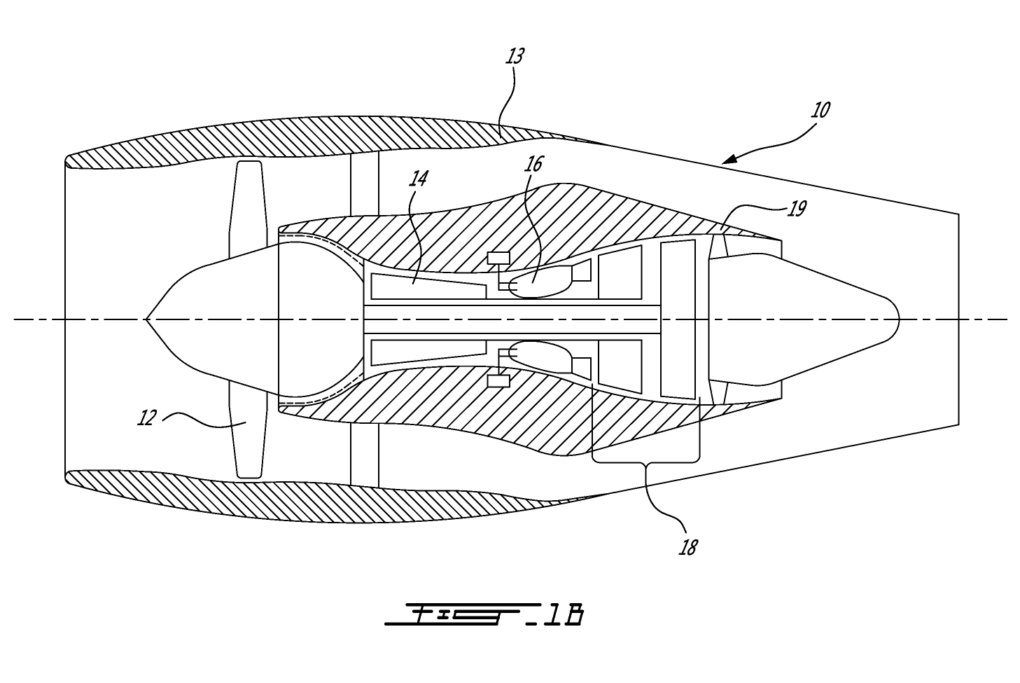

FIGS. 1A and 1B illustrate a turbofan gas turbine engine 10 of a type preferably provided for use in subsonic flight, generally comprising in serial flow communication a fan 12 in an outer case 13 through which ambient air is propelled, a multistage compressor 14 for pressurizing the air, a combustor 16 in which the compressed air is mixed with fuel and ignited for generating an annular stream of hot combustion gases, and a turbine section 18 in a turbine case 19 for extracting energy from the combustion gases. The gas turbine engine 10 of FIG. 1A is a short cowl engine, whereas the gas turbine engine 10 of FIG. 1B is a long cowl engine.

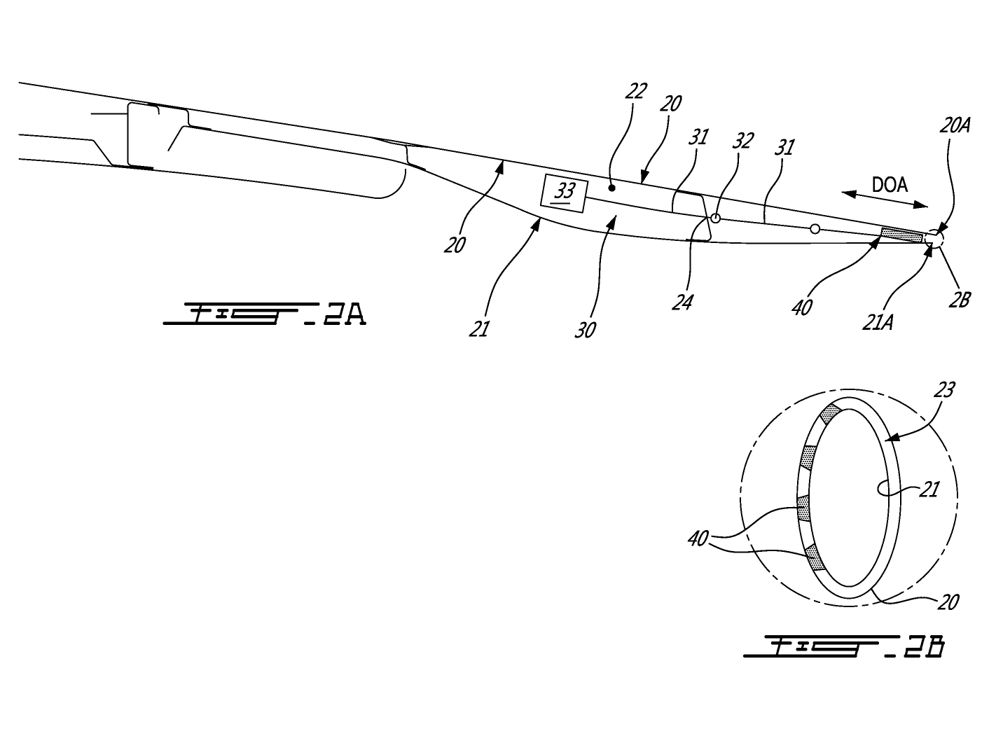

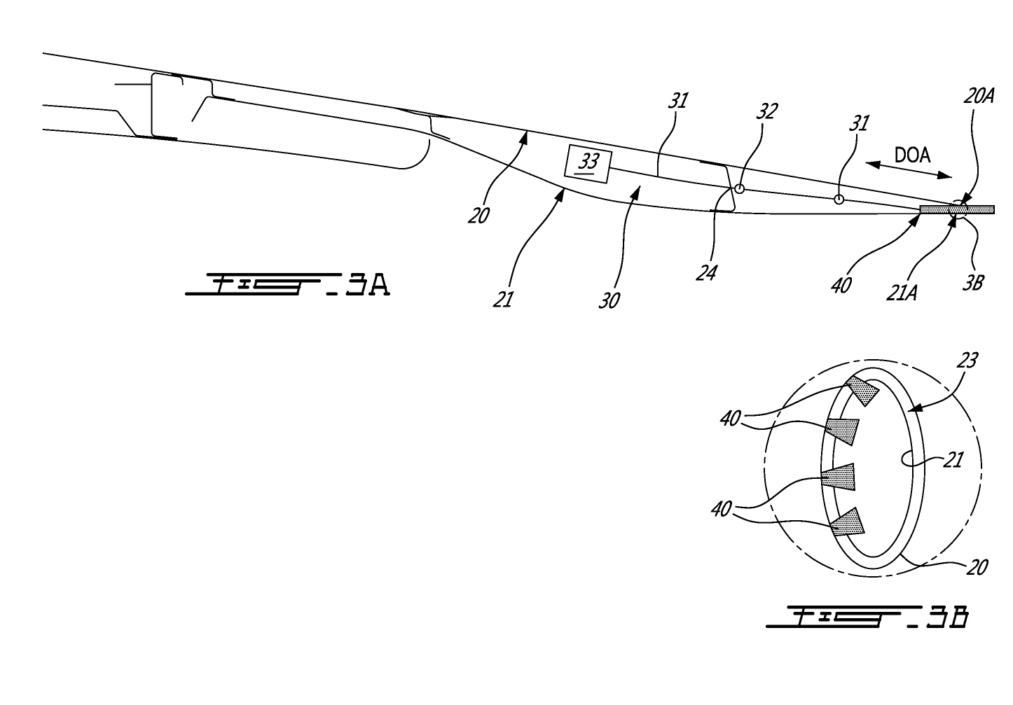

Referring to FIGS. 2A and 3A, a gas turbine engine case or nacelle is shown as having an outer skin 20, an inner skin 21, so as to define an inner cavity 22 therebetween. The gas turbine engine case is annular, whereby the inner cavity 22 is annular, as observed from FIGS. 2B and 3B. An annular opening 23 is circumscribed by trailing edges 20A and 21A of the outer skin 20 and of the inner skin 21, respectively. According to an embodiment, the outer skin 20 and the inner skin 21 are part of a thrust reverser, for instance forming an end frame pivotable at pivot frame 24, and separable from a remainder of the nacelle.

A chevron deployment mechanism is generally shown at 30, and is mostly concealed in the inner cavity 22. The chevron deployment mechanism 30 may feature linkages 31 and joints 32, operated by an actuator 33. However, it is considered to use any appropriate type of chevron deployment mechanism 30 to provide one or more translational degrees of actuation (DOAs) to displace chevrons between a stowed configuration and a deployed configuration. For example, there may be more or fewer of the linkages 31 and joints 32, or alternatively or additionally, rods, tendons, chains, linear actuators, cylinders, valves and like hardware components could be used to provide the translation DOA. Moreover, the DOA may be provided by any available type of actuators, such as electric, pneumatic, hydraulic, electro-mechanical, among possibilities. This is discussed in further detail hereinafter.

The mechanism 30 is connected to one or more deployable chevrons 40, that may be displaced to a deployed configuration, as shown concurrently by FIGS. 3A and 3B, from a stowed configuration shown concurrently by FIGS. 2A and 2B. As observed in FIGS. 2B and 3B, chevrons are circumferentially distributed within the outer skin 20, and all or a part of these chevrons may be deployable chevrons 40, or a mixture of fixed chevrons and deployable chevrons 40. The deployable chevrons 40 lie between the outer skin 20 and inner skin 21 when in the stowed configuration.

The expression “chevron” is used as the deployable chevrons 40 described herein perform the same function as the sawtooth pattern chevrons integral with the outer skin of gas turbine engine cases. However, other expressions may be used to qualify such chevrons, such as silencers, flaps, tabs, sound-suppressing means, etc, all of which are encompassed by the present disclosure. The chevrons 40 may also include air-through chevrons, also known as hollow tabs. For simplicity, the expression chevron is used throughout the specification, but encompasses these other types of devices as well, and the expression “surface-increasing features” is used in the claims to cover the multiple possible embodiments described above.

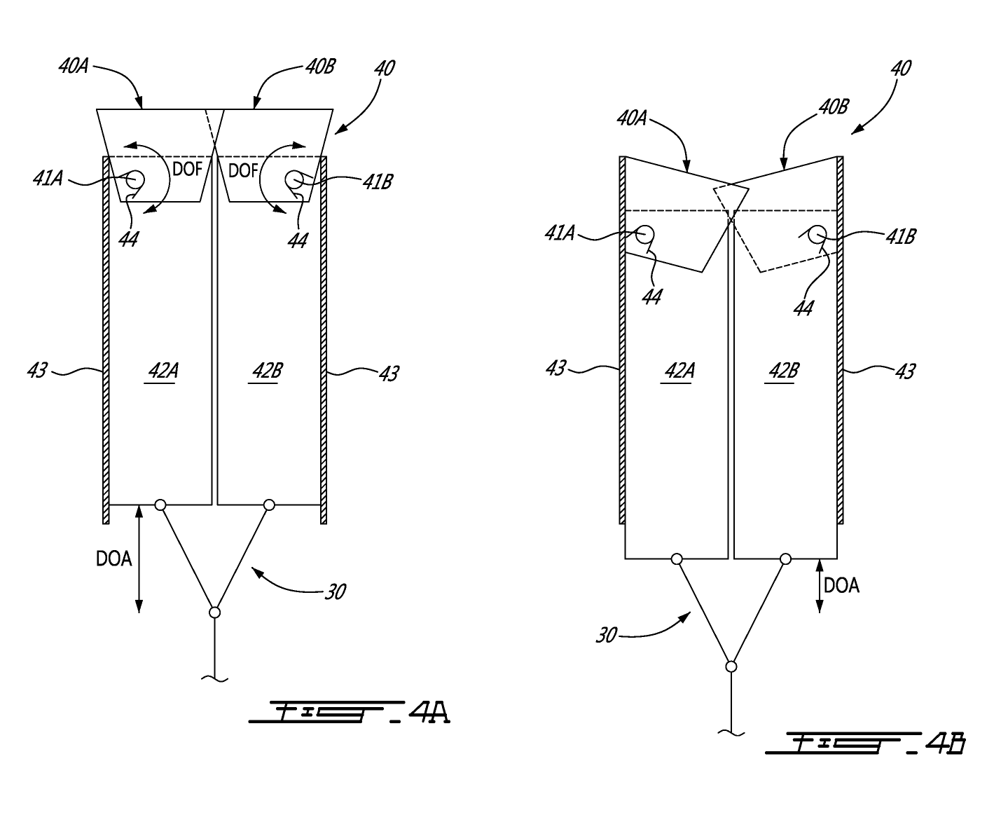

Referring to FIGS. 4A and 4B, one of the deployable chevrons 40 is shown in greater detail, and has a first panel 40A and a second panel 40B (a.k.a., flaps, sheet metal parts, flat polygons, plates, etc). The deployable chevron 40 is part of a chevron system featuring one or more degrees of freedom (DOFs) for the panels 40A and 40B, relative to the chevron deployment mechanism 30. Stated differently, the panels 40A and 40B may move independently from the chevron deployment mechanism 30. In FIGS. 4A and 4B, the DOF are rotational joints 41A and 41 B, by which the panels 40A and 40B are connected to tie rods 42A and 42B, respectively. The tie rods 42A and 42B may be a part of the chevron deployment mechanism 30, or may be part of the chevron system. Accordingly, the joints 41A and 41B may connect the panels 40A and 40B directly to the chevron deployment mechanism 30. The rotational joints 41A and 41 B may be rivets, hinges, pivots, etc.

The chevron system also has a guide 43 operatively contacting the panels 40A and 40B. Referring to FIGS. 4A and 4B, the guide 43 may be a pair of walls contacting edges of the panels 40A and 40B, the guide 43 forming a housing with its walls to enclose the panels 40A and 40B in the stowed configuration. Therefore, as guided by the guide 43, the first panel 40A and the second panel 40B move toward one another in the DOF in response to movement induced by the translational DOA of the chevron deployment mechanism 30, from the deployed configuration (FIG. 4A) to the stowed configuration (FIG. 4B), by the walls of the guide 43 forcing the panels 40A and 40B to move into overlapping one another. Likewise, the guide 43 may guide the first panel 40A and the second panel 40B to move away from one another in the DOF in response to movement induced by the translational DOA of the chevron deployment mechanism 30, from the stowed configuration (FIG. 4B) to the deployed configuration (FIG. 4A). Stated differently, the DOF allows an angular movement (or translational movement in another embodiment) of the panels 40A and 40B relative to the deployment mechanism 30, the angular movement being about an axis generally transverse to the axis of the engine and/or to a direction of the translational DOA. The two panels 40A and 40B may rotate in two separate planes, generally or substantially parallel to one another, such that they overlap each other and are constrained by the guide 43 in the stowed configuration, and may lie substantially away from each other in the deployed configuration, when employed concurrently in noise reduction function. Any of these movements may be assisted by other components or conditions, such as biasing means 44 (for a common tie rod 42), gravity, air flow, etc. The guide 43, although shown as featuring walls, may take different configurations, such as cam and follower, guide and slot, abutments, etc, acting on the edges of the panels 40A and 40B, or other parts thereof. The embodiments could include use of different springs to pre-load the panels 40A and 40B of the chevron 40.

Referring to FIGS. 4A and 4B, a footprint of the chevron 40, concurrently defined by the first panel 40A and the second panel 40B, is greater in the deployed configuration of FIG. 4A than in the stowed configuration of FIG. 40B. The footprint is defined by the surface covered by the chevron 40 (i.e., the first panel 40A and the second panel 40B), from a plane view, i.e., the effective noise-suppressing surface. The point of view of the footprint in FIGS. 4A and 4B is generally normal to a main plane of the chevron 40. The footprint is greater in the deployed configuration as the panels 40A and 40B are moved away from one another to reduce the overlap between the panels 40A and 40B. In doing so, the deployable chevron 40 may have a larger effective surface when in the deployed configuration, and may be stowed in a smaller footprint, reducing the footprint surface required to stow the deployable chevron 40.

The panels 40A and 40B of the deployable chevron 40 may have any appropriate shape, although a trapezoidal or truncated triangular shape may be considered for noise reduction effectiveness. The trapezoidal or truncated triangular shape may be oriented such that the large side of these shapes is the trailing edge of the chevrons 40, i.e., the chevrons 40 flare beyond the trailing edge of the case. Such an inverted geometry provides an additional interface length, and creates increased singularities within the flow, thus creating favorable conditions for generation of more and stronger streamwise vortices which may result in sharper plume decay and hence a noise reduction.

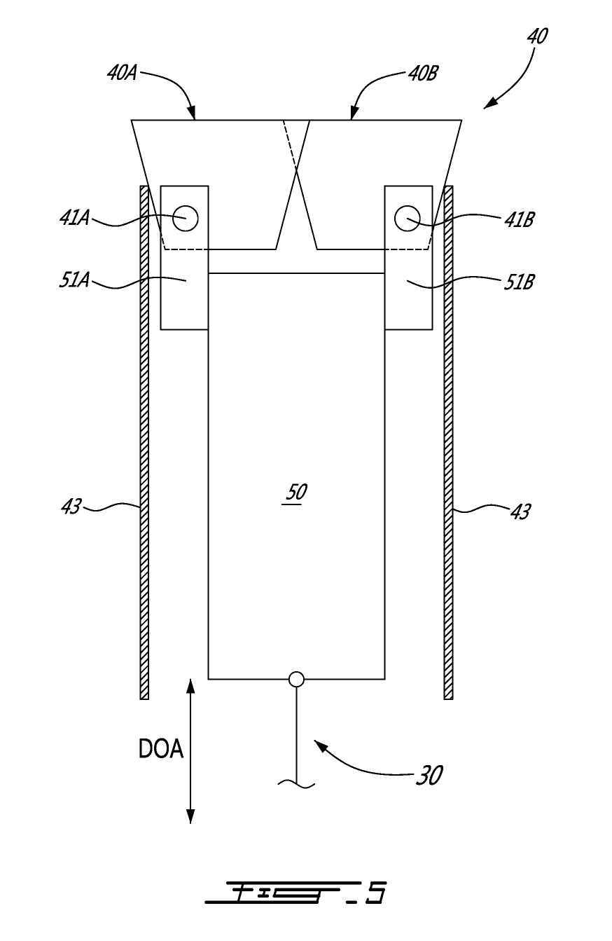

Referring to FIG. 5, another embodiment of the chevron system is shown, having similarities with the chevron system of FIGS. 4A and 4B, whereby like reference numeral will relate to like elements. In FIG. 5, the first panel 40A and the second panel 40B are connected to a common tie rod 50, via respective support arms 51A and 51B. The panels 40A and 40B therefore translate concurrently as driven by the translational DOA on the tie rod 50. The guide 43 will displace the panels 40A and 40B in the rotational DOFs to deploy or stow the chevron 40.

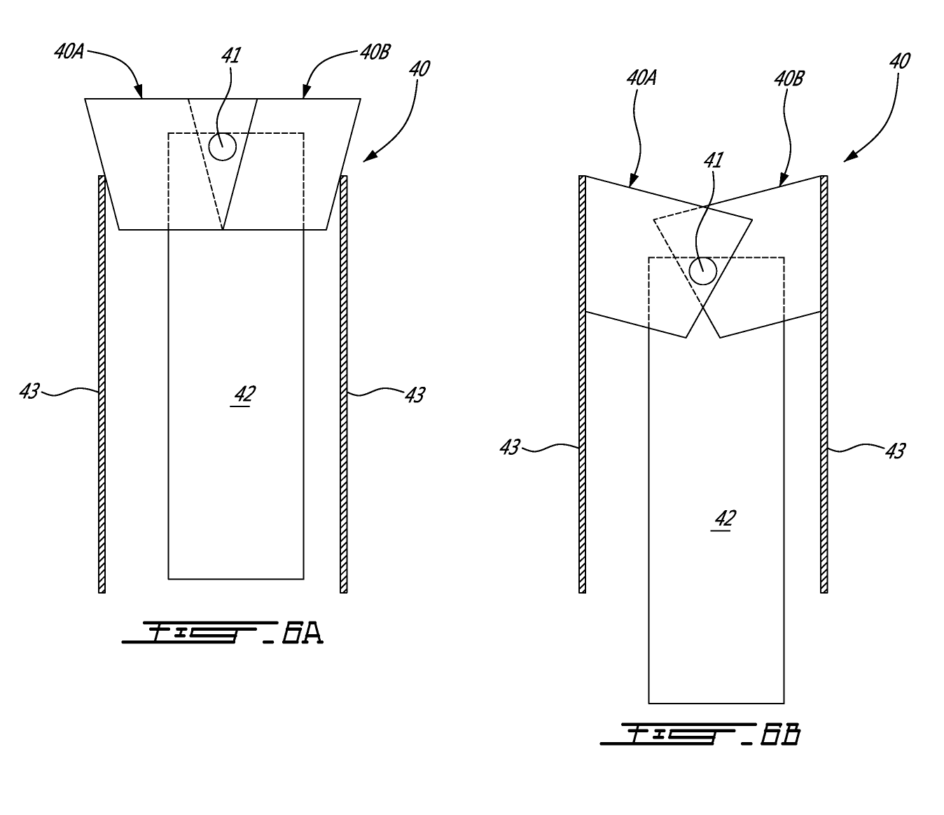

Other arrangements are considered for the chevron system. For example, referring to FIGS. 6A and 6B, the panels 40A and 40B may share a common pivot 41 and thus rotate about the same rotational axis, and translate as driven by a common tie rod. The panels 40A and 40B may be interconnected to share a common DOF relative to the deployment mechanism 30, or each have an independent DOF relative to the deployment mechanism 30. Similarly, other embodiments could include combine multiple pieces of tie-rods, support-arms and knife edges to create the desired shape of the chevron.

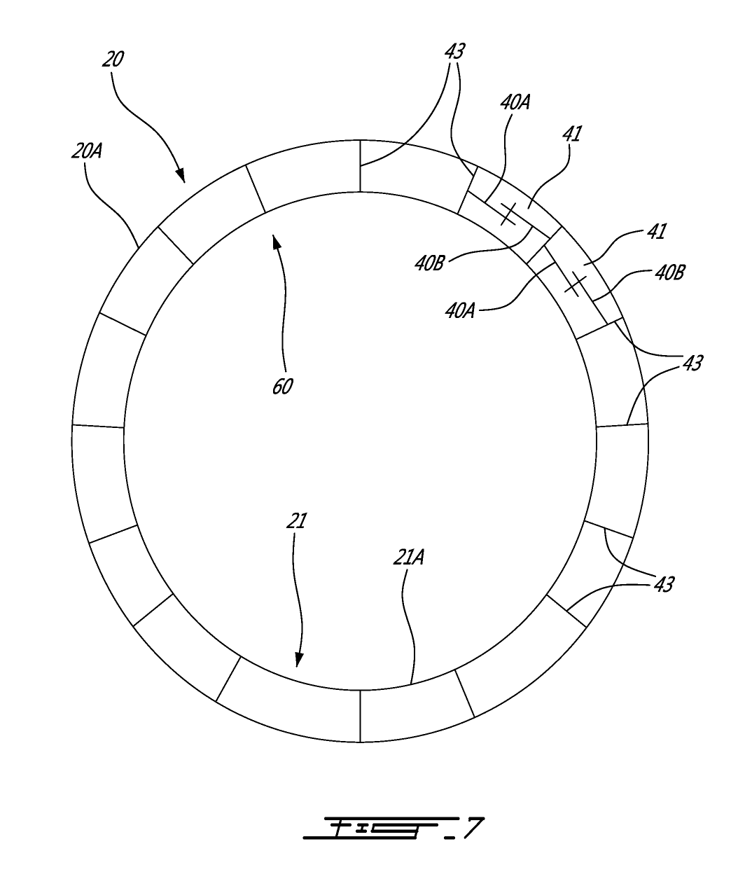

Referring to FIG. 7, walls of the guide 43 may be connected to an end frame 60 in different ways. For example, the end frame 60 is shown featuring the skins 20 and 21. The guides 43 may act as structural reinforcement members transversely and radially disposed in the end frame 60 and extending between the skins 20 and 21, to reinforce the end frame 60. Alternatively, components of the guide 43 may be rigidly mounted to the reinforcement members or other parts of the end frame 60.

In another embodiment, the end frame 60 may feature separate constructional details along different circumferential sectors, to allow for installation of the guides 43 only along a specific sector of the end frame 60.

When the skins 20 and 21 are part of a thrust reverser, the chevron deployment mechanism 30 is positioned strategically relative to a pivoting location of the thrust reverser, so as not to hamper the pivoting movement.

As observed from FIG. 3B, the deployed chevrons 40 extends beyond the trailing edges of the skins 20 and 21, whereby the chevrons 40 interact with the flow streams around the skins 20 and 21, thus creating a vortical flow structure that contributes to jet noise reduction. The deployed configuration may be used at a typical take-off and/or landing maneuver, such that the chevrons 40 expose the active surfaces, thereby initiating a stronger vortical flow, resulting in a reduction in the jet/mixer noise.

The chevron deployment mechanism 30 may be designed to operate in a ‘FAIL-CLOSE’ mode wherein the deployable chevrons 40 continuously stay in the stowed configuration, so as to minimize the hydraulic/pneumatic/mechanical load under the failure condition.

Within the embodiments, the hydraulic pressurization can be achieved through existing sources of hydraulic pressure on an engine, e.g. the actuation lines for the thrust reversers can be modified appropriately for translating the chevrons 40. Similar results can be achieved by using existing sources of hydraulic pressure on an aircraft or using a separate stand-alone source. Similarly, pneumatic actuation can be achieved by using high pressure air available from the engine and/or a stand-alone source located on the engine or aircraft.

The line used for conveying the fluid for translating the chevrons 40 may include flexible pipelines or a combination of rigid and flexible pipelines packaged between the skins 20 and 21 of the case. Another embodiment may feature a single line from the pressurizing source until a splitter beyond which multiple pressurizing lines may be used for translating the chevrons 40. Similarly, another embodiment may feature multiple pressurizing sources that may translate a single or multiple chevrons 40. In another embodiment, if the actuation is based on pneumatic pressure the return line may not be required and the depressurizing may be achieved by discharging directly into the thrust reverser.

The use of the expression chevron is used as the deployable panels 40A and 40B described above perform the same function as the sawtooth pattern chevrons integral with the outer skin of gas turbine engine cases. However, other expressions may be used to qualify such chevrons, such as silencers, flaps, sound-suppressing means, etc, all of which are encompassed by the present disclosure.

Therefore, a method for deploying the panels 40A and 40B forming the chevron 40 at the trailing edge 20A/21A comprises receiving a translational degree of actuation (or translational actuation) to move the chevron 40 beyond the trailing edge 20A/21A. The two panels 40A and 40B are guided in rotatably moving relative to one another as induced by the translational actuation to increase a footprint of the deployable chevron 40 concurrently defined by the first panel 40A and the second panel 40B. Moving the two panels 40A and 40B comprises rotating the two panels 40A and 40B about axes transverse to a direction of the translational actuation. Guiding the two panels 40A and 40B comprises operatively contacting edges of the two panels 40A and 40B. The method may be performed simultaneously for a plurality of chevrons 40.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A surface-increasing feature system for a gas turbine engine comprising:
at least one deployable surface-increasing feature defined at least by a first panel and a second panel connected to a deployment mechanism providing a translational actuation to deploy said deployable surface-increasing feature from a stowed configuration in which the deployable surface-increasing feature is substantially concealed fore of a trailing edge of a case of the gas turbine engine, to a deployed configuration in which the deployable surface-increasing feature extends beyond the trailing edge;
at least one joint providing at least one degree of freedom for the first panel and the second panel relative to the deployment mechanism; and
a guide operatively contacting the deployable surface-increasing feature to rotatably displace the first panel and the second panel away from one another in the at least one degree of freedom in response to movement induced by the translational actuation from the stowed configuration to the deployed configuration;
whereby a footprint of the deployable surface-increasing feature concurrently defined by the first panel and the second panel is greater in the deployed configuration than in the stowed configuration.

2. The surface-increasing feature system according to claim 1, wherein the first panel and the second panel lie in parallel planes.

3. The surface-increasing feature system according to claim 1, wherein the at least one joint is rotational joints connecting the first panel and the second panel to the deployment mechanism, the rotational joints receiving the translational actuation.

4. The surface-increasing feature system according to claim 3, wherein axes of the rotational joints are transverse to a direction of the translational actuation.

5. The surface-increasing feature system according to claim 1, further comprising at least one tie rod between the panels and the deployment mechanism, the tie rod pushing and pulling the panels as actuated by the translational actuation.

6. The surface-increasing feature system according to claim 5, wherein the at least one joint is at least one rotational joint connecting the first panel and the second panel to the at least one tie rod.

7. The surface-increasing feature system according to claim 6, comprising two of said at least one joint, wherein axes of the rotational joints are transverse to a direction of the translational actuation.

8. The surface-increasing feature system according to claim 1, wherein the first panel and the second panel each have a trapezoid shape.

9. The surface-increasing feature system according to claim 1, wherein the guide operatively contacts edges of the first panel and the second panel.

10. The surface-increasing feature system according to claim 9, wherein the guide has walls contacting said edges of the first panel and of the second panel, the walls concurrently forming a housing for the surface-increasing feature in the stowed configuration.

11. The surface-increasing feature system according to claim 1, wherein the footprint of the surface-increasing feature flares beyond the trailing edge.

12. The surface-increasing feature system according to claim 1, further comprising at least one biasing member biasing the panels to the deployed configuration.

13. A chevron system for a gas turbine engine comprising:
at least one chevron defined by a pair of panels, each panel having at least two degrees of freedom, with one degree of freedom consisting of a rotational movement of said panel around a joint and another degree of freedom consisting of translational movement of said panel within a guide;
a biasing member for biasing the panels in said rotational movement, wherein said rotational movement is restricted by the guide; and
a deployment mechanism for moving each panel within the guide.

14. The chevron system according to claim 13, wherein each said guide has walls contacting said edges of the first panel and of the second panel, the walls concurrently forming the housing for the panels in the stowed configuration.

15. The chevron system according to claim 13, further comprising at least one tie rod between the panels and the deployment mechanism.

16. The chevron system according to claim 15, wherein the joint is rotational joints connecting the first panel and the second panel to the at least one tie rod.

17. A method for deploying a pair of panels forming a surface-increasing feature at a trailing edge of a case of a gas turbine engine of an aircraft, comprising:
receiving a translational actuation to move the surface-increasing feature beyond the trailing edge; and
guiding the two panels in rotatably moving relative to one another as induced by the translational actuation to increase a footprint of the deployable surface-increasing feature concurrently defined by the first panel and the second panel.

18. The method according to claim 17, wherein guiding the two panels comprises rotating the two panels about axes transverse to a direction of the translational actuation.

19. The method according to claim 17, wherein guiding the two panels comprises operatively contacting edges of the two panels.

20. The method according to claim 17, wherein guiding the two panels comprises biasing the two panels in operative contact with a guide when increasing the footprint.
